(19) United States
(12) Patent Application Publication
(10) Pub. No.: US 2023/0083272 A1
(43) Pub. Date: Mar. 16, 2023

(54) PUNCH-HOLE SKETCHES TO BOOST LOWER-ARM MUSCLES AND FINE MOTOR-SKILLS OF KIDS

(71) Applicants: Nishi Pahuja, Frisco, TX (US); Mehul Pahuja, Frisco, TX (US)

(72) Inventors: Nishi Pahuja, Frisco, TX (US); Mehul Pahuja, Frisco, TX (US)

(21) Appl. No.: 17/475,916

(22) Filed: Sep. 15, 2021

(51) Int. Cl. B42F 3/00; G09B 11/00

(52) U.S. Cl. CPC B42F 3/003; G09B 11/00; B42D 15/0006

(57) ABSTRACT

The present invention relates to punch-hole learning activities for kids, for enhancing psychomotor skills and for strengthening their muscles of the forearm, hand, and fingers and increasing the eye-hand coordination among them. It discloses a paper having preexisting punch holes and patterns surrounding the punch holes with a collection of drawings that form a story for enhancing the fine motor skills among kids. The patterns are connected to give a predefined structure that relates to one another. The punch hole learning activity through filler papers enables kids to coordinate between their mental ability with the hand movement, and therefore improves their fine motor skills.

### FIELD OF THE INVENTION

The present invention relates to a process of creating a visual story by utilizing a filler paper with preexisting punch holes. More particularly, the present invention relates to a forming a story strip for kids to invoke interest in kids with a story strip and in doing so, it will strengthen the muscles of their forearm, hand, and fingers and increase their eye-hand coordination.

### BACKGROUND OF THE INVENTION

Filler paper are loose sheets available in economical packages so as to use the required amount of pages when and where necessary. Punch holes are holes in filler papers often used for the purpose of collecting the sheets in a binder or folder. The most common standard for the dimensions and location of filing holes punched in paper is International Standard ISO 838. Two holes with a diameter of 6±0.5 mm are punched into the paper. The centers of these holes are 80±0.5 mm apart and have a distance of 12±1 mm to the nearest edge of the paper. The holes are located symmetrically in relation to the axis of the sheet or document. Any paper format that is at least 100 mm high (e.g. ISO A7 and larger) can be filed using this system. A printed document with a margin of 20-25 mm will accommodate ISO 838 filing holes.

Psychomotor ability refers to a wide range of actions involving physical movement related to conscious cognitive processing. Fine motor skills involve using muscle groups in our hands, fingers, and wrists in a controlled manner. We continue developing these skills during the toddler to the school age years and it forms a critical time for physical and cognitive growth.

U.S. Pat. No. 1,107,193 discloses an idea of animating on pages with pre-printed backgrounds and cross marks to align the drawings with punch holes. The process of producing moving pictures includes producing a series of pictures on separate sheets of translucent material, photographing said pictures in succession on a kinematograph film with proper position for the object in each picture being secured by superposing the sheet upon which the object is to be shown upon the sheet showing the object in the last successive position and with guide marks in registry, whereby the object shown on the second-mentioned sheet is visible through the first-mentioned sheet.

U.S. Pat. No. 1,143,542 discloses use of transparent cellulose sheets bound as a bundle much like making a flip-book wherein, punch-holes are used as an element of the sketches. It also describes making animated cartoons with minimum effort and expense. The process facilitates the rapid execution of any series of poses relating to or constituting a single scene, using a single setting or background for an entire scene and affecting the illusion of lifelike movement in successive poses by drawing upon a series of transparent sheets with the moving objects arranged progressively according to the sequence of the events.

U.S. Pat. No. 1,375,918 discloses a 2-round-hole peg system to combine cells with the background using a form of double exposure-matte process.

However, in the above-described prior art, the objectives of drawing utilizing punch-holes are towards animation, developing flip books or in exposure-matte. The main differences of the described documents above are that they do not focus on utilizing punch holes in having sketches displayed on paper with use of punch boles in them and enhancing fine motor skills of children, and having a story between the holes that are connected through a means of designs and using the punch holes as a part of the art that communicates a story.

Therefore, there is a need of utilizing punch holes and the unutilized area of a paper sheet for fun activities and enhancing fine motor skills among kids that enable kids to strengthen the muscle and coordination skills. By using filler papers for such activities, one can use the area left unused for some constructive purpose.

### OBJECTS OF THE INVENTION

A main object of the present invention is to develop punch hole story art and drawing activities for kids ranging from toddlers to preschoolers till early childhood.

Another object of the present invention is to use the preexisting punch holes on filler paper for kids to strengthen the muscles of their forearm and hand, increase eye-hand coordination, and enhance fine-motor skills with art.

Additionally, another object of the present invention is to use the punch holes on filler paper to enable kids to coordinate their mental ability thought process with their hand movements.

Yet another object of the present invention is to provide a connection of patterns displayed on the filler paper that includes drawings using the preexisting punch holes in the designs, and having the punch holes related to one another to convey a storyline.

### SUMMARY OF THE INVENTION

The present invention provides a filler paper with an art story around punch holes for kids for strengthening their muscles of the forearm, hand, and fingers and increasing their eye-hand coordination.

In a main embodiment, the present invention provides a filler paper comprising preexisting punch holes on an edge of filler paper with illustrations surrounding the punch holes that are displayed onto paper. The filler paper is either ruled or blank. The illustrations when joined gives a predefined structure and a pattern between the punch holes. The patterns can include multiple designs that always are related to one another in the form of a story and which is printed onto paper in a traceable format.

In another embodiment, the present invention provides a method of creating a visual story by utilizing a filler paper with preexisting punch holes, wherein, the method comprising the steps of: a) providing drawing patterns surrounding the punch holes; b) understanding the design hidden in the patterns; and c) joining the patterns through a writing instrument to form different designs, wherein different designs depict different segments of a story or different designs depict different stages of a process. Said method improves fine motor skills of children.

### BRIEF DESCRIPTION OF THE DRAWINGS

FIG. 1 shows an example of design on triple punch holes of the present invention in accordance with an embodiment of the present invention with story of playing with a ball.

FIG. 2 shows an example of design on triple punch holes to form a story of a development of a bee in accordance with an embodiment of the present invention.

### DESCRIPTION OF THE INVENTION

The present invention provides a punch hole learning activity for strengthening muscles of the forearm, hand, and fingers as well as increasing eye-hand coordination among kids. The present invention provides a filler paper where preexisting punch holes are found along the edge of a paper and a collection of patterns are encompassing the punch holes. The patterns are connected to give a predefined structure of numerous characters that are part of a story. The punch hole learning activity through filler paper enables kids to coordinate their mental thought process with the hand movement.

In a main embodiment, the present invention provides a filler paper comprising preexisting punch holes on edges of said filler paper and of patterns surrounding the punch holes. The designs surrounding the punch holes, once combined, create a story that, when utilized by children through tracing or coloring in, improves their fine motor skills.

In another embodiment, the present invention provides a method of creating a visual story by utilizing a filler paper with preexisting punch holes, wherein, the method comprising the steps of: a) providing patterns surrounding the punch holes; b) understanding the design hidden in the patterns; and c) joining patterns through a writing instrument to form different designs, wherein different designs depict different segments of a story or different designs depict different stages of a process. Said method improves fine motor skills of children.

The present invention helps in utilizing the punch holes on the side of the paper to be used as part of a story strip. Each of the punch holes would be included as part of the image which forms part of the story strip.

The goal of this invention is to enable a story using designs that incorporate the punch holes in the layout. The present invention also helps in understanding and visualizing the story and to have children trace them along or make changes by coloring in among other options.

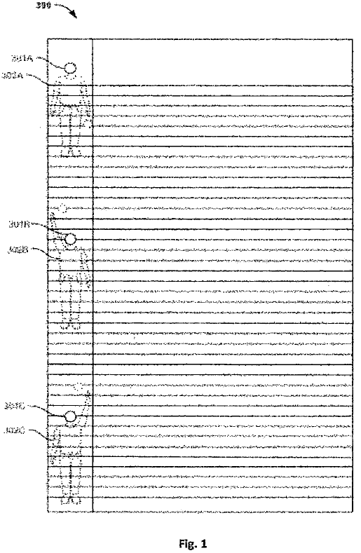

Referring to FIG. 1, the present invention depicts an example of triple punch-hole drawing on a filler paper 300 where the punch holes 301a, 301b and 301c and set of dots 302a, 302b and 302c are provided for shape of a person with different positions of their hands. The punch hole 301a is positioned on edge of filler paper 300. The set of dots 302a are positioned around the punch hole 301a. The set of dots 302a are connected together by kids to create the shape of a person holding a ball 303. The punch hole 301a is given a shape of the person's head and the set of dots 302a resembles the shape of a person's full body such as arms, legs, stomach, chest, fingers, and shoes. In this way, kids learn the body parts of a person and positions of person's hand and strengthen their muscles and also enhance their fine motor skills.

Similarly, the punch hole 301b is positioned on edge of filler paper 300. The set of dots 302b are positioned around the punch hole 301b. The set of dots 302b are connected together by kids to create the shape of man throwing the ball 303. The punch hole 301b is given a shape of the man head and the set of dots 302b resembles the shape of a man full body such as arms, legs, stomach, chest, fingers, shoes. In this, way kids learn the body parts of man and positions of man's hand of throwing the ball and strengthen their muscles also enhance their fine motor skills.

Similarly, the punch hole 301c is positioned on edge of filler paper 300. The set of dots 302a are positioned around the punch hole 301c. The set of dots 302c are connected together by kids to create the shape of a person throwing the ball 303 from different hands. The punch hole 301c is given a shape of the person's head and the set of dots 302c resemble the shape of a man's full body such as arms, legs, stomach, chest, fingers, and shoes. In this way, kids learn the body parts of a person and the positions of a person's hand and strengthen their muscles and also enhance their fine motor skills.

FIG. 1 basically shows shapes of three people whose heads are formed from the punch-holes (301a, b, c) and are depicted as catching ball 303 from the top punch hole 301a to the second punch hole 301b and the lowest punch hole 301c. This depiction is an attempt to enable rightful coordination of the eye-hand and also motor skills.

In this way, a story is shown by having the first punch hole depict a person dropping a ball, which continues to be handed to the second person/punch hole, then have it end at dropping towards the last punch hole/person. This collection of illustrations demonstrates a story plotline, and it has several steps that make up the whole narration. By having the punch holes be depicted as characters, it combines together where each punch hole plays a role in a larger story or plot.

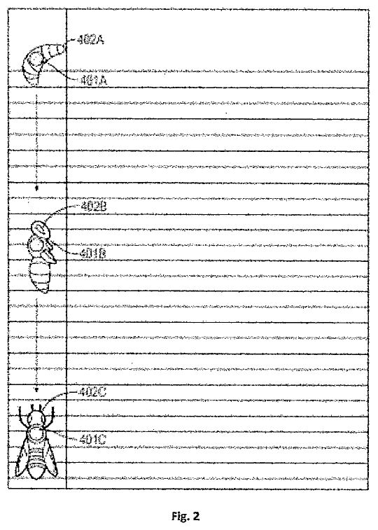

Referring to FIG. 2, the present invention depicts an example of design on triple punch holes to form a story in accordance with an embodiment of the present invention. the three punch holes 401A, 401B and 401C would form a storyline form for the life cycle of a bee from a larva 401A, to a pupa 401B, to a bee 401C. The punch holes in sequence would depict the sequential life phases of a bee. The punch hole at the top 401A surrounds a design 402A of a larva. The middle hole 401B surrounds a design 402B for the pupa. The bottom punch hole 401C surrounds a design 402C for the bee. Kids can easily join the dotted pattern and form the story about the lifecycle of a bee. In this way, kids would learn about different life cycle stages as well as body parts of a bee and also strengthen their muscles.

In an example, the present invention can be used to draw different stages of the lifecycle of a human being from a baby to a child and to an adult.

Another example could be a story of basketball game where the bottom punch hole of the three is a person playing basketball. Their head is the punch hole and they are dribbling the ball. Then the drawing shows them passing the basketball to the person whose head is the middle punch hole. This person catches the ball, then shoots the ball to the top punch hole, which is the basketball hoop's rim, and connected to the rim is the net, which shows the basketball inside it, indicating they made it in. In between each punch hole is the ball with movement lines below it to show the movement of the basketball from person to person to net. This can help remind kids of how basketball works and teach them more about teamwork.

As the kids align the punch hole designs and work through the story using mental thought and draw some structure, it helps kids to coordinate their hand with mind.

Therefore, the present invention provides the punch hole learning activity for kids using filler paper through which kids enjoy its activity while enhancing their fine motor skills.

What has been described above includes examples of the intended subject matter. It is, of course, not possible to describe every conceivable combination of components or methodologies for purposes of describing the intended subject matter, but one of ordinary skill in the art may recognize that many further combinations and permutations of the intended subject matter are possible. Accordingly, the disclosed subject matter is intended to embrace all such alterations, modifications and variations that fall within the spirit and scope of the appended invention.

1. (canceled)

2. (canceled)

3. (canceled)

4. (canceled)

5. (canceled)

6. (canceled)

7. (canceled)

8. (canceled)

9. (canceled)

10. (canceled)

11. A method of creating a visual story by utilizing a filler paper with preexisting punch holes, wherein the method comprising the steps of:
a) providing a plurality of patterns surrounding the punch holes;
b) understanding a plurality of design hidden in said plurality of patterns; and
c) connecting said plurality of patterns through a writing instrument to form different designs,
wherein said method improves fine motor skills of children.

12. The method of creating a visual story as claimed in claim 6, wherein different designs depict different segments of a story.

13. The method of creating a visual story as claimed in claim 6, wherein different designs depict different stages of a process.

14. The method of creating a visual story as claimed in claim 6, wherein different designs depict different characters of a story.
